(19) United States
(12) Patent Application Publication
(10) Pub. No.: US 2013/0194180 A1
(43) Pub. Date: Aug. 1, 2013

(54) DEVICE AND METHOD OF CONTROLLING THE SAME

(71) Applicants: Wooseok AHN, Seoul (KR); Yongwon CHO, Seoul (KR)

(72) Inventors: Wooseok AHN, Seoul (KR); Yongwon CHO, Seoul (KR)

(73) Assignee: LG ELECTRONICS INC., Seoul (KR)

(21) Appl. No.: 13/359,536

(22) Filed: Jan. 27, 2012

(51) Int. Cl. G09G 5/08

(52) U.S. Cl. 345/157

(57) ABSTRACT

A device and a method of controlling the device are provided. The device includes a sensing unit, and a controller configured to generate a display signal displaying at least one pointer, to generate a display signal so that the a movement of the at least one pointer depending on a first gesture is performed based on a first set value when obtaining the first gesture through the sensing unit, and to generate a display signal so that the movement of the at least one pointer depending on the first gesture is performed based on a second set value when the first set value changes to the second set value. Accordingly, it may be possible to effectively control movement of the pointer by enabling the pointer to be moved based on a predetermined set value.

### BACKGROUND

1. Technical Field

The embodiments of the present invention are directed to a device and a method of controlling the device, and more specifically to a device and a method of controlling the device, which may effectively control movement of the pointer by enabling the pointer to be moved based on a predetermined set value.

2. Related Art

As terminals, such as personal computers, laptop computers, and mobile phones, come to have a diversity of functions, such terminals are being implemented as multimedia players that may provide various functions, such as image or video capturing, audio or video replay, games, receipt of broadcasting, etc.

From the fact that such terminals generally entail a function of displaying various image information, such terminals, as a multimedia player, may be called “display devices”. The display devices may be categorized into portable type and stationary type according to mobility. Portable type display devices include, for example, laptop computers or mobile phones and stationary type display devices include, for example, TVs and monitors for desktop computers.

### SUMMARY

The embodiments of the present invention are directed to a device and a method of controlling the device that may effectively control movement of the pointer by enabling the pointer to be moved based on a predetermined set value.

One innovative aspect of the subject matter described in this specification is embodied in a device that includes a sensing unit configured to sense gestures of a user, wherein the sensing unit senses the gestures without the user physically contacting the device or any hardware in communication with the device. The device also includes a controller configured to: generate a display signal to cause a display unit to display a pointer; receive, from the sensing unit, information associated with a first gesture of the user sensed by the sensing unit; generate, while receiving information associated with the first gesture, a display signal to cause the display unit to display the pointer with movement corresponding to a function of the first gesture and a first set value; change, while receiving information associated with the first gesture, the first set value to a second set value, the first set value being different than the second set value, and generate, while receiving information associated with the first gesture and after changing the first set value to the second set value, a display signal to cause the display unit to display the pointer with movement corresponding to a function of the first gesture and the second set value.

Other embodiments of these aspects include corresponding systems, methods, and computer programs, configured to perform the actions of the methods, encoded on computer storage devices.

These and other embodiments may each optionally include one or more of the following features. For instance, the first set value may correspond to a first ratio between a trajectory distance of the first gesture and a corresponding travel distance of the pointer. The second set value may correspond to a second ratio between a trajectory distance of the first gesture and a corresponding travel distance of the pointer. The controller may be configured to generate a display signal to cause the display unit to display the pointer with movement corresponding to a function of the first gesture and the first set value by generating a display signal to cause the display unit to display the pointer moving a first travel distance corresponding to the first ratio and a first trajectory distance of the first gesture. The controller may be configured to generate a display signal to cause the display unit to display the pointer with movement corresponding to a function of the first gesture and the second set value by generating a display signal to cause the display unit to display the pointer moving a second travel distance corresponding to the second ratio and a second trajectory distance of the first gesture after the first set value has been changed to the second set value.

The first ratio may be smaller than the second ratio. The controller may be configured to change the first set value to the second set value based on the sensing unit sensing a change in the first gesture. The controller may be configured to receive information associated with the first gesture of the user by receiving information associated with the first gesture of the user being performed using a hand. The sensing unit may be configured to sense a change in the shape of the hand of the first user performing the first gesture. The controller may be configured to change the first set value to the second set value based on the sensing unit sensing the change in the shape of the hand of the user performing the first gesture.

The controller may be configured to receive information associated with the first gesture of the user by receiving information associated with the first gesture of the user being performed using a hand. The sensing unit may be configured to sense a change in a distance between a body of the user performing the first gesture and the hand of the user and an angle between the body and the hand. The controller may be configured to change the first set value to the second set value based on the sensing unit sensing the change in the distance between the body of the user performing the first gesture and the hand of the user and an angle between the body and the hand.

The controller maybe configured to receive information associated with the first gesture of the user by receiving information associated with the first gesture of the user being performed using a hand. The sensing unit may be configured to sense a change in at least one of a degree at which the hand of the user performing the first gesture extends forward from a body of the user or a height of the hand of the user with respect to the body of the user. The controller may be configured to change the first set value to the second set value based on the sensing unit sensing the change in least one of the degree at which the hand of the user performing the first gesture extends forward from the body of the user or the height of the hand of the user with respect to the body of the user.

The controller may be configured to receive information associated with the first gesture of the user by receiving information associated with the first gesture of the user being performed using a hand. The sensing unit may be configured to sense a change in a travelling speed of the hand of the user performing the first gesture. The controller may be configured to change the first set value to the second set value based on the sensing unit sensing the change in the travelling speed of the hand of the user performing the first gesture.

The controller may be configured to: generate a display signal to cause the display unit to display a selectable object configured to receive a selection signal; determine that the pointer has moved within a certain distance of the selectable object; and change, based on determining that the pointer has moved within the certain distance of the selectable object, the first set value to the second set value.

The sensing unit may be configured to sense data indicative of a maximum reach of the user. The controller may be configured to: determine, based on the sensed data, the maximum reach of the user; and set the first set value based on the maximum reach of the user.

The controller may be configured to: receive, from the sensing unit, information associated with a second gesture of the user sensed by the sensing unit; and display, based on receiving the information associated with the second gesture of the user, an expanded viewing area at a current position at which the pointer is displayed, the expanded viewing area displaying a magnified view of a region around the current point at which the pointer is displayed.

The controller may be configured to receive information associated with the first gesture of the user by receiving information associated with the first gesture of the user being performed using a first hand. The controller may be configured to receive information associated with the second gesture of the user by receiving information associated with the second gesture of the user being performed using a second hand.

The device and method of controlling the device according to the embodiments of the present invention may effectively control movement of the pointer by enabling the pointer to be moved based on a predetermined set value.

### BRIEF DESCRIPTION OF THE DRAWINGS

FIG. 1 illustrates a block diagram of a device according to an embodiment of the present invention;

FIG. 2 illustrates an example where the device of FIG. 1 is controlled by using the user's gesture;

FIG. 3 is a flowchart illustrating an operation of the device shown in FIG. 1;

FIG. 4 illustrates an example where the device shown in FIG. 1 moves the pointer P depending on a gesture;

FIGS. 5 and 6 are views illustrating a relationship between a travelling trajectory of the pointer and a gesture in the device shown in FIG. 1;

FIGS. 7 to 9 are views illustrating a relationship for a pointer's travelling trajectory depending on a set value in the device shown in FIG. 1;

FIGS. 10 and 11 are views illustrating an example where the device shown in FIG. 11 changes a set value depending on a hand's shape;

FIGS. 12 and 13 are views illustrating an example where the device shown in Fig. changes a set value depending on a relationship between a hand and body;

FIGS. 14 and 15 are views illustrating an example where the device shown in FIG. 1 changes a set value depending on a distance between a hand and a body;

FIG. 16 is a view illustrating a relationship between a radius of a hand and a movement of a pointer in the device shown in FIG. 1; and

FIGS. 17 and 18 are views illustrating an example where the device shown in FIG. 1 expands the screen depending on a gesture.

### DESCRIPTION OF THE EMBODIMENTS

The present invention will now be described more fully with reference to the accompanying drawings, in which exemplary embodiments of the invention are shown. The invention may, however, be embodied in many different forms and should not be construed as being limited to the embodiments set forth herein; rather, there embodiments are provided so that this disclosure will be thorough and complete, and will fully convey the concept of the invention to those skilled in the art.

Hereinafter, a mobile terminal relating to the present invention will be described below in more detail with reference to the accompanying drawings. In the following description, suffixes “module” and “unit” are given to components of the mobile terminal in consideration of only facilitation of description and do not have meanings or functions discriminated from each other.

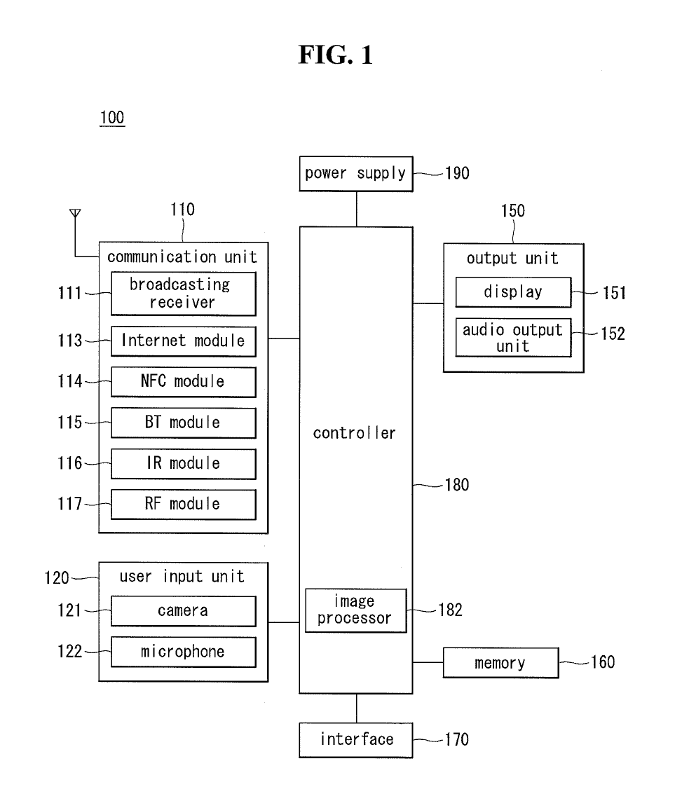

The mobile terminal described in the specification can include a cellular phone, a smart phone, a laptop computer, a digital broadcasting terminal, personal digital assistants (PDA), a portable multimedia player (PMP), a navigation system and so on. FIG. 1 illustrates a block diagram of a device related to one embodiment of the present invention.

As shown in the figure, a device 100 according to one embodiment of the present invention comprises a communication unit 110, a user input unit 120, an output unit 150, a memory 160, an interface unit 170, a controller 180, and a power supply 190. The components shown in FIG. 1 are those commonly found in a device; therefore, devices can be implemented with a larger or a smaller number of components than that of FIG. 1.

The communication unit 110 can include more than one module which enables communication between the device 100 and a communication system or between the device 100 and other devices. For example, the communication unit 110 can include a broadcasting receiver 111, an Internet module 113, a near field communication (NFC) module 114, a Bluetooth (BT) module 115, an infrared (IR) module 116, and a radio frequency (RF) module 117.

The broadcasting receiver 111 receives a broadcasting signal and/or broadcasting-related information from an external broadcasting management server through a broadcasting channel.

The broadcasting channels can include a satellite and a terrestrial channel. The broadcasting management server can indicate a server generating and transmitting broadcasting signals and/or broadcasting-related information; or a server receiving broadcasting signals and/or broadcasting-related information and transmitting them to terminals. The broadcasting signals include TV broadcasting signals, radio broadcasting signals, and data broadcasting signals. Furthermore, the broadcasting signal can further include such a broadcasting signal in the form of a combination of a TV broadcasting signal or a radio broadcasting signal with a data broadcasting signal.

The broadcasting-related information can correspond to the information related to broadcasting channels, broadcasting programs, or broadcasting service providers. The broadcasting-related information can also be provided through a communication network.

The broadcasting-related information can be provided in various forms. For example, the broadcasting-related information can be provided in the form of EPG (Electronic Program Guide) of DMB (Digital Multimedia Broadcasting) or ESG (Electronic Service Guide) of DVB-H (Digital Video Broadcast-Handheld).

The broadcasting receiver 111 can receive broadcasting signals by using various broadcasting systems. The broadcasting signal and/or broadcasting-related information received through the broadcasting receiver 111 can be stored in the memory 160.

The Internet module 113 is a module for connecting to the Internet. The Internet module 113 can be installed inside or outside the device 100.

The NFC (Near Field Communication) module 114 is a module carrying out communication according to NFC protocol. The NFC module 114 can commence communication through tagging motion for NFC devices and/or NFC tags. For example, if an electronic device with NFC function is tagged to the device 100, it indicates that an NFC link can be established between the electronic device and the device 100. The electronic device and the device 100 can transmit and receive necessary information to and from each other through the established NFC link.

The Bluetooth module 115 is a module carrying out communication according to Bluetooth protocol. The Bluetooth module 115 carries out communication based on short range wireless networking technology co-developed by Bluetooth SIG (Special Interest Group). By using the Bluetooth module 115, the device 100 can carry out Bluetooth communication with other electronic devices.

The infrared module 116 is a module carrying out communication by using infrared rays.

The radio frequency (RF) module 117 is a module carrying out wireless communication with the device 100. The RF module 177 can employ a communication technology different from the other communication modules mentioned earlier.

The user input module 120 is used for inputting audio or video signals, which can include a camera 121, a microphone 122, etc.

The camera 121 processes image frames such as photos or videos obtained by an image sensor at video telephony mode or shooting mode. The image frames processed can be displayed on the display unit 151. The camera 121 can correspond to a camera 121 capable of 2D or 3D imaging, where the camera 121 can consists of a single 2D or 3D camera or a combination of both.

Image frames processed by the camera 121 can be stored in the memory 160 or transmitted to the outside through the communication unit 110. Depending on the configuration of the device 100, two or more cameras 121 can be installed.

The microphone 122 receives external sound signals and transforms the received signals to voice data in the telephony mode, recording mode, or voice recognition mode. The microphone 122 can employ various noise suppression algorithms to remove noise generated while external sound signals are received.

The output unit 150 can include a display unit 151 and an audio output unit 152.

The display unit 151 displays information processed within the device 100. For example, the display unit 151 displays an UI (User Interface) or a GUI (Graphic User Interface) related to the device 100. The display unit 151 can employ at least one from among liquid crystal display, thin film transistor-liquid crystal display, organic light-emitting diode, flexible display, and 3D display. In addition, the display unit 151 can be implemented in the form of a transparent or light-transmission type display, which can be called a transparent display. A typical example of a transparent display is a transparent LCD. The rear structure of the display unit 151 can also employ the light-transmission type structure. Thanks to the above structure, the user can see objects located in the back of the terminal body through the area occupied by the display unit 151 of the body.

Depending on how the device 100 is implemented, two or more display units 151 can exist. For example, in the device 100, multiple display units 151 can be disposed being separated from each other or as a whole body in a single area; alternatively, the multiple display units 151 can be disposed respectively in different areas from each other.

In the case where the display unit 151 and a sensor detecting a touch motion (hereinafter, it is called a touch sensor) form a mutual structure between them (hereinafter, it is called a touch screen), the display unit 151 can also be used as an input device in addition to an output device. The touch sensor can take the form of a touch film, a touch sheet, and a touch pad, for example.

A touch sensor can be formed in such a way to transform the change of pressure applied to a particular part of the display unit 151 or the change of capacitance generated at a particular part of the display unit 151 into the corresponding electric signal. The touch sensor can be so fabricated to detect the pressure at the time of touch motion as well as the touch position and area.

When a touch input is applied to the touch sensor, a signal corresponding to the touch input is forwarded to a touch controller. The touch controller processes the signal and transfers the data corresponding to the signal to the controller 180. In this way, the controller 180 can know which area of the display unit 151 has been touched.

The audio sound unit 152 can output audio data received from the communication unit 110 or stored in the memory 160. The audio sound unit 152 can output sound signals related to the functions carried out in the device 100 (for example, a call signal receiving sound and a message receiving sound). The audio output unit 152 can comprise a receiver, a speaker, and a buzzer.

The memory 160 can store programs specifying the operation of the controller 180 and temporarily store input/output data (for example, a phonebook, a message, a still image, and a video). The memory 160 can store data related to various patterns of vibration and sound generated at the time of touch input on the touch screen.

The memory 160 can be realized by at least one type of storage media including flash type memory, hard disk, multimedia card micro memory, card type memory (e.g., SD or XD memory), RAM (Random Access Memory), SRAM (Static Random Access Memory), ROM (Read-Only Memory), EEPROM (Electrically Erasable Programmable Read-Only Memory), PROM (Programmable Read-Only Memory), magnetic memory, magnetic disk, and optical disk. The device 100 can function in association with a web storage which can perform a storage function of the memory 160 on the Internet.

The interface unit 170 serves as a passage to all the external devices connected to the device 100. The interface unit 170 receives data from external devices or receives power and delivers the received data and power to each of constituting components within the device 100 or transmits the data within the device 100 to external devices. For example, the interface unit 170 can include a wired/wireless headset port, an external charger port, a wired/wireless data port, a memory card port, a port connecting a device equipped with an identification module, an audio I/O (Input/Output) port, a video I/O port, and an earphone port.

The controller 180 usually controls the overall operation of the device. For example, the controller 180 carries out control and processing for voice, data, and video communication. The controller 180 can be equipped with an image processor 182 for processing images. Description of the image processor 182 will be provided more specifically in the corresponding part of this document.

The power supply 190 receives external and internal power according to the control of the controller 180 and provides power required for the operation of each constituting component.

Various embodiments described in this document can be implemented in a computer or in a recording medium readable by a device similar to the computer, both of which utilizing software, hardware, or a combination of software and hardware. As for hardware implementation, the embodiment of this document can be implemented by using at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, micro-controllers, micro-processors, and electric units for carrying out functions. In some cases, the embodiments can be implemented by the controller 180.

As for software implementation, embodiments such as procedures or functions can be implemented together with separate software modules supporting at least one function or operation. Software codes can be implemented by a software application written by a relevant programming language. Also, software codes can be stored in the memory 160 and carried out by the controller 180.

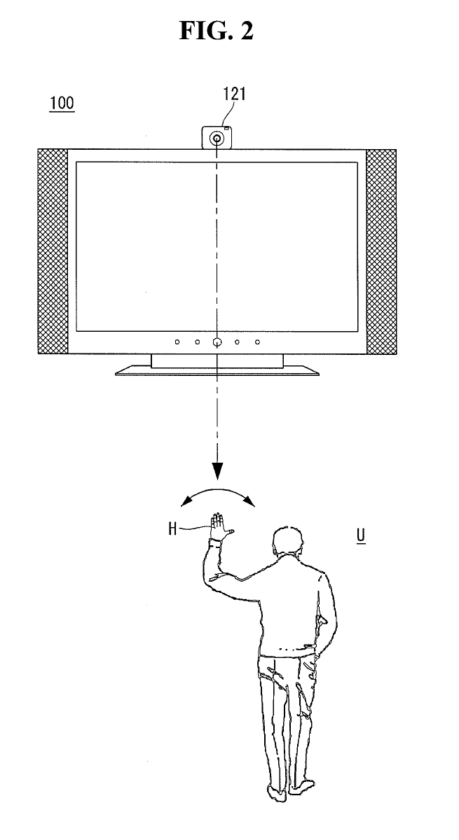

FIG. 2 illustrates an example where the device of FIG. 1 is controlled by using the user's gesture.

As shown in the figure, the control right for the device 100 can be given to the user (U) if the user (U) attempts a particular motion. For example, if the user's (U) motion of raising and waving his or her hand (H) left and right is set as the motion for obtaining the control right, the user carrying out the motion can acquire the control right.

If a user with the control right is found, the controller 180 tracks the user. Authorizing and tracking the user can be carried out based on images captured through the camera prepared in the device 100. In other words, it indicates that the controller 180 can continuously determine whether a particular user (U) exists by analyzing the captured images; whether the particular user (U) carries out a gesture required for obtaining the control right; and whether the particular user (U) carries out a particular gesture.

The particular gesture of the user can correspond to the motion for carrying out a particular function of the device 100 or for stopping a particular function in execution. For example, the particular gesture can correspond to the motion of selecting various menus displayed in three-dimensional images by the device 100.

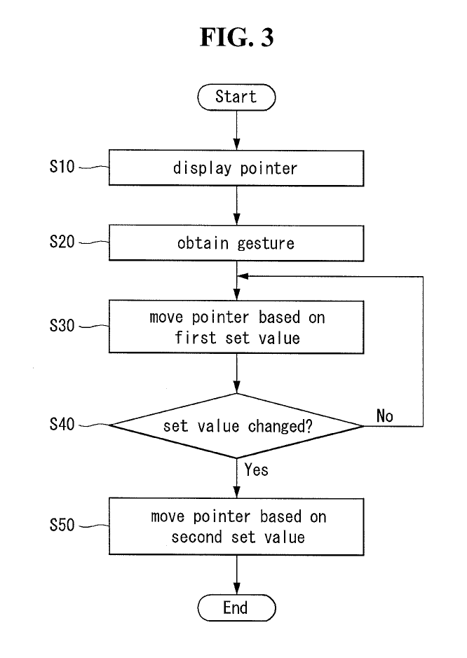

FIG. 3 is a flowchart illustrating an operation of the device shown in FIG. 1.

Referring to FIG. 3, the controller 180 of the device 100 may perform a step S10 of displaying a pointer P.

The device 100 may include the controller 180 of generating a display signal for displaying the pointer P. The controller 180 of the device 100 may transmit the generated display signal to a display 151 included in the device 100 or a display 151 provided separately from the device 100.

The pointer P may be an object that enables an operation of selecting an object displayed on the display unit 151 to be performed. For instance, the object includes an object shaped as an arrow or a cursor, or an object of highlighting a predetermined area to distinguish the predetermined area from another area, as displayed on the display unit 151. For example, the pointer P is not limited to having a certain shape, for example, an arrow shape.

The pointer P may appear or disappear, or changes in shape or move in response to a control signal generated by a user and/or the controller 180. For example, the pointer P may reflect a result of the control signal generated by the user and/or the controller 180. The pointer P may be selectively displayed. For example, the pointer is displayed at a predetermined time but not at another time. The user and/or the controller 180 may enable the pointer P to be displayed when selection and/or input needs to be made on the display unit 151.

A step S20 of obtaining a gesture may be performed.

The gesture may be obtained through various sensing units. The sensing units may include at least one 2D and/or 3D camera 121, an ultrasonic sensor that may measure a distance and/or location, and an IR (Infrared) sensor. For purposes of illustration, the sensing unit is the camera 121.

The gesture may be conducted by a user. The controller 180 may extract the user's image from an image obtained through the camera 121. For example, the controller 180 may separate a background image from a user's image. According to an embodiment, when a plurality of users are captured, only an image for a user who has a right for the device among the plurality of users may be extracted. The gesture may be obtained by analyzing a change overtime in the user's image and/or the user's image at a predetermined time. The gesture may be distinguished from a “posture” that may be defined as a motion at a predetermined time. However, hereinafter, the “gesture” and “posture” may be collectively referred to as the “gesture”. For example, the device according to an embodiment may apply to both the gesture and the posture.

A step S30 may be performed which moves the pointer P based on a first set value.

The first set value may act as a basis for determining a degree of movement of the pointer P according to the obtained user's gesture. For example, the first set value may be a criterion necessary for properly reflecting the user's gesture. For example, when the user conducts a gesture of moving his hand by a distance of 10 from left to right, it may be determined how far the pointer P is to be moved in which direction.

A step S40 of determining whether the first set value is changed may be performed.

The first set value may be changed. As described above, the first set value may be a basis for determining the degree of movement of the pointer P according to the gesture. When the first set value is changed, even when the user conducts the same gesture, the degree of movement of the pointer P including a travelling distance may be changed.

The first set value may be changed based on a control signal from the controller 180 and/or by the user.

For example, the user and/or the controller 180 may change the first set value by conducting a predetermined gesture at a predetermined time.

The predetermined time that the first set value is changed may be a time that accuracy is required for an operation of the pointer P, such as selecting a predetermined object by the pointer P or a time that a large movement is needed while accuracy is required. The device 100 according to an embodiment may change the first set value depending on situations. For example, the device 100 may be controlled by a gesture to be optimized for a corresponding situation.

A step S50 of moving the pointer P based on a second set value may be performed.

The second set value may be a variation of the first set value.

When the first set value changes to the second set value, the controller 180 may enable the pointer P to be moved based on not the first set value but the second set value. For example, even when the user makes a hand gesture for moving the point P by the same distance, the traveling distance of the pointer P may be changed.

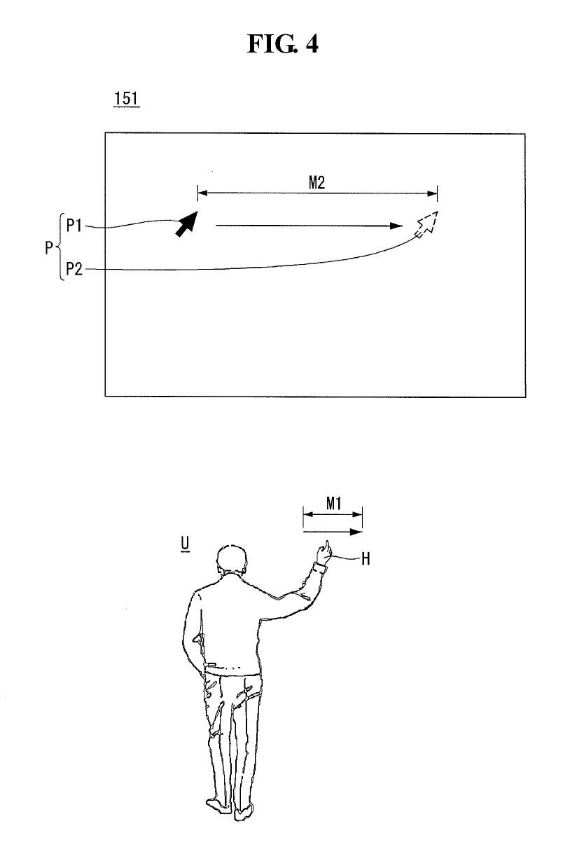

FIG. 4 illustrates an example where the device shown in FIG. 1 moves the pointer P depending on a gesture.

Referring to FIG. 4, the device 100 may enable the pointer P to be moved according to a gesture of a user U.

The controller 180 may display the pointer P on the display unit 151. The pointer P may be first positioned at a point P1.

The user U may conduct a gesture using his hand H.

The gesture of the user U may be obtained by the camera 121.

When the gesture is obtained by the camera 121, the controller 180 may move the pointer P based on a set value. For example, the controller 180 may generate a control signal that enables the pointer P first located at the point P1 to be relocated to a point P2.

A distance of the user's gesture may be M1. For example, the user U moves his hand H by a distance of M1 from right to left. A travelling distance of the pointer P corresponding to the distance M1 may be M2. As the gesture is conducted to move the hand H by M1, the controller 180 may move the pointer P by M2.

The travelling distance of the pointer P with respect to the distance of the gesture may be determined based on the set value. For example, there may be a criterion of forming a relationship between the travelling distance of the pointer P and the distance of the gesture so that when the distance of the gesture is 10, the travelling distance of the pointer P is 1.

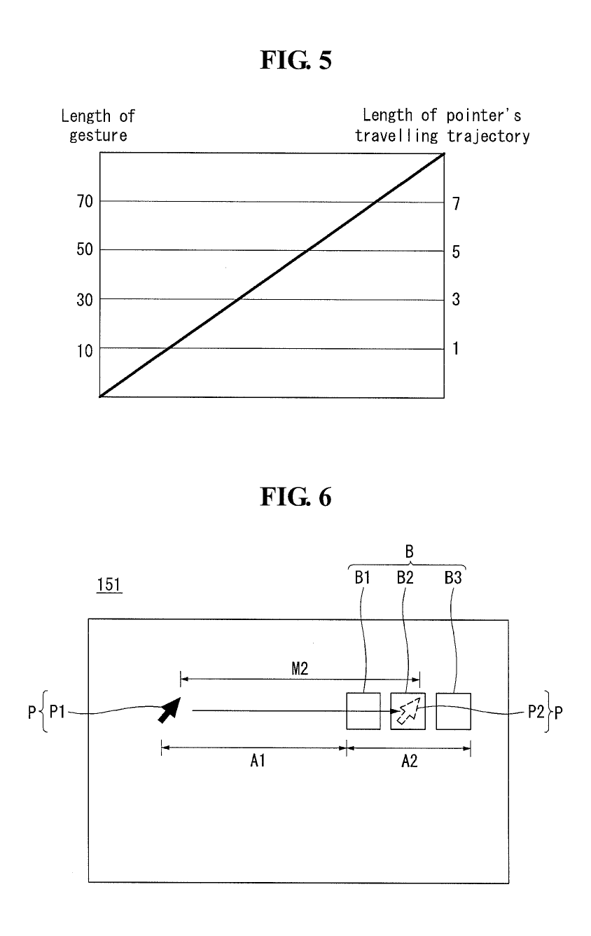

FIGS. 5 and 6 are views illustrating a relationship between a travelling trajectory of the pointer and a gesture in the device shown in FIG. 1.

Referring to FIGS. 5 and 6, the controller 180 of the device 100 may determine a location of the pointer P based on a set value for determining a length of a travelling trajectory of the pointer depending on a length of a gesture.

As shown in FIG. 5, there may be a predetermined correlation between a length of a gesture and a length of a travelling trajectory of the pointer. For example, the length of the gesture may be in direct proportion to the length of the travelling trajectory of the pointer.

When the length of the gesture is 10, the length of the pointer's travelling trajectory may be 1. For example, a relationship of 10:1 may exist between the gesture and movement of the pointer. According to such ratio, when lengths of the gesture are 30, 50, and 70, lengths of the pointer's travelling trajectory may be 3, 5, and 7, respectively. However, the ratio is merely an example, and the embodiments of the present invention are not limited thereto.

As shown in FIG. 6, the pointer P may be desired to be relocated from a point P1 to a point P2. Buttons B may be located near the point P2. The user may desire to select a second button B2 of the buttons B using the pointer P. The travelling trajectory of the pointer P from the point P1 to the point P2 may be divided into a first trajectory A1 and a second trajectory A2.

No object such as the buttons B may be present over the first trajectory A1, and an object such as the buttons B may be present over the second trajectory A2.

Different set values for determining a degree of movement of the pointer P may apply to the first and second trajectories A1 and A2, respectively. For example, the pointer P may move a relatively long distance with a relatively short gesture over the first trajectory A1, and the pointer P may move a relatively short distance with a relatively short gesture over the second trajectory A2.

It may be apparently understood to need to change the set value considering that it is not easy to accurately control the buttons B when the pointer P moves over the second trajectory A2 at the same rate as over the first trajectory A1. For example, assuming that there is such a set value that as enabling the pointer P to be moved by 1 when the travelling distance of the gesture over the first trajectory A1 is 10, if a movement is made with the same set value over the second trajectory A2, the button B may be difficult to select. For example, if the pointer P is configured to be moved with the same sensitivity all the time, the pointer P may be difficult to control when an accurate movement is necessary.

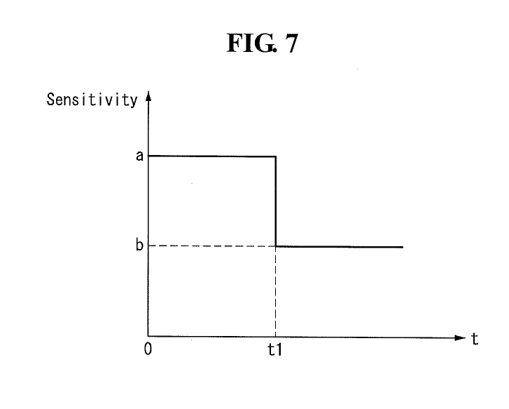

FIGS. 7 to 9 are views illustrating a relationship for a pointer's travelling trajectory depending on a set value in the device shown in FIG. 1.

Referring to FIGS. 7 to 9, the device 100 may change a set value at a predetermined time based on a control signal from the controller 180 and/or by a user.

As shown in FIG. 7, a change in the set value may include a change in sensitivity. For example, a movement of the pointer P according to a gesture may be performed based on a sensitivity a at a predetermined time and based on a sensitivity b at another predetermined time.

A time t1 that the sensitivity a changes to the sensitivity b may be when the user makes a predetermined gesture or the controller 180 performs a predetermined control operation. For example, the sensitivity may change when the user's hand H moves away from his body by a predetermined distance.

The sensitivities a and b may be 1 and 0.5, respectively. For example, the controller 180 may move the pointer P with a sensitivity of 1 in response to the user's gesture until the time t1, and since the time t1, the controller 180 may move the pointer P with a sensitivity of 0.5 in response to the user's gesture. For example, when a gesture of 10 is conducted, the pointer P may be moved by 10 before the time t1, but after the time t1, the pointer P may be moved by 0.5. Accordingly, after the time t1, the user may move the pointer P more accurately.

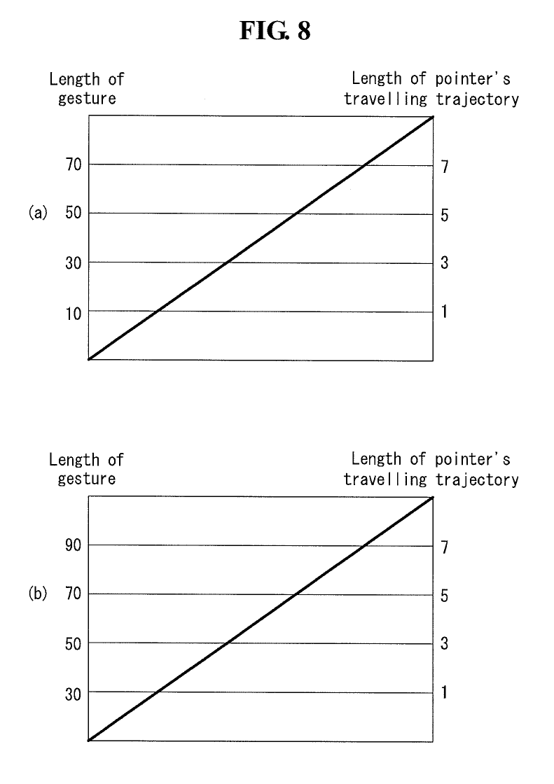

Referring to FIG. 8, a length of a pointer's travelling trajectory with respect to a length of a gesture may change.

As shown in FIG. 8A, when lengths of the gesture are 10, 30, 50, and 70, lengths of the pointer's travelling trajectory may be 1, 3, 5, and 7, respectively.

As shown in FIG. 8B, after a predetermined time, when lengths of the gesture are 30, 50, 70, and 90, lengths of the pointer's travelling trajectory may be 1, 3, 5, and 7, respectively. For example, the set value may change after the predetermined time.

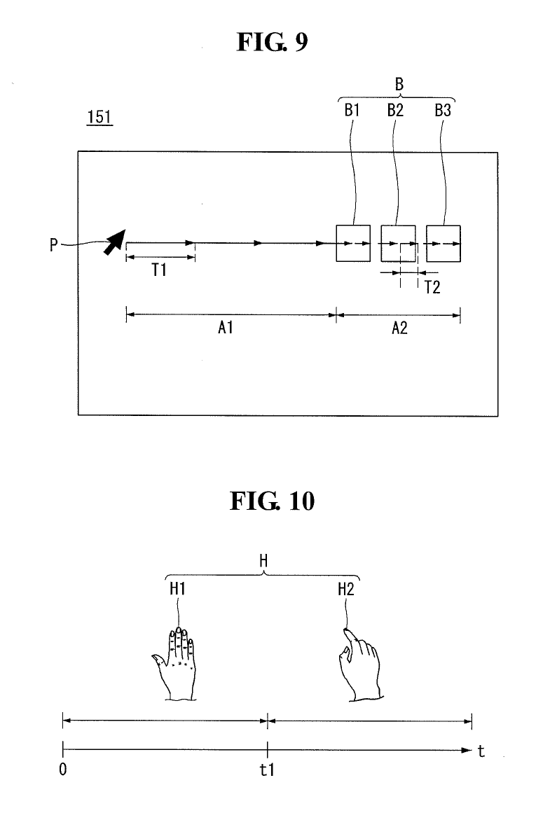

Referring to FIG. 9, the pointer P may move based on different set values in areas corresponding to the first and second trajectories A1 and A2. When the user conducts a gesture with a first length in the area corresponding to the first trajectory A1, the controller 180 may enable the pointer P to be moved by a first travelling distance T1. When the user conducts a gesture with the same length as the first length in the area corresponding to the second trajectory A2, the controller 180 may enable the pointer P to be moved by a second travelling distance T2. For example, by the user conducting the same gesture, the pointer P may move different distances along the first and second trajectories A1 and A2.

Since the pointer P moves a short distance along the second trajectory A2 even when the same gesture is conducted, the pointer P may be controlled with more accuracy. Accordingly, the user may easily select the buttons B.

The controller 180 may automatically change a set value when the pointer P moves near the buttons B. For example, the controller 180 may enable the pointer P to be moved based on a first set value when the pointer P is located over the first trajectory A1 and based on a second set value when the pointer P is located over the second trajectory A2.

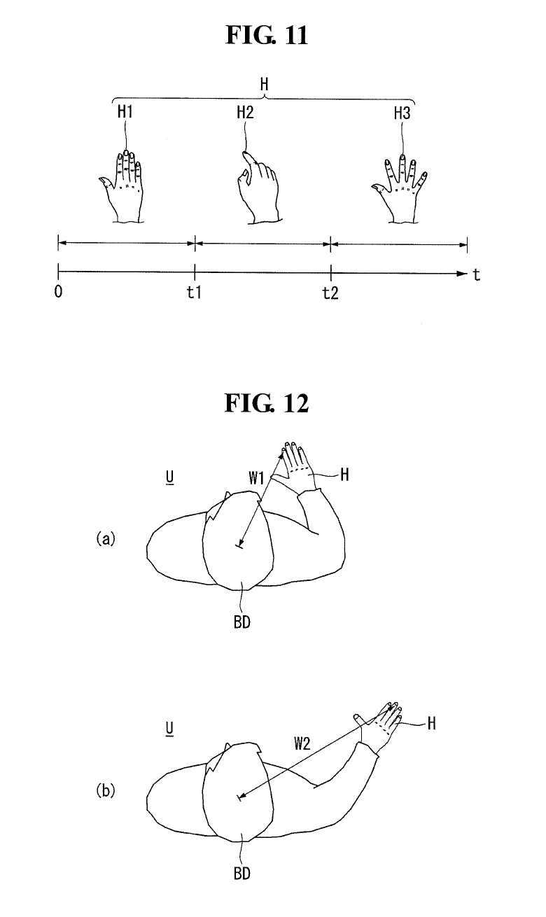

FIGS. 10 and 11 are views illustrating an example where the device shown in FIG. 11 changes a set value depending on a hand's shape.

Referring to FIGS. 10 and 11, the controller 180 of the device 100 may change a set value based on a time that a user conducts a predetermined gesture.

As shown in FIG. 10, before a time t1, the user may conduct a gesture while opening his hand H. For example, the user may conduct a gesture of moving his hand H from left to right with the hand H open. At the time t1, the user may conduct a gesture while opening a single finger. For example, the user may conduct a gesture of moving his hand H from left to right with a single finger open.

Before and after the time t1, a travelling speed or distance of the user's hand H may not be changed. However, before and after the time t1, the shape of the hand H may change. At a time that the shape of the user's hand H changes, the controller 180 may change a set value. For example, before the time t1, the sensitivity for a gesture may be large and after the time t1, the sensitivity for the gesture may be small.

At a time that requires accurate control on the pointer P, the user may change the shape of the hand H. For example, when hovering over the display unit 151, a control operation may be carried out while the user's hand is left open, and when selecting the buttons B, a control operation may be carried out while a single finger is left open.

The controller 180 may change a set value that may control a movement of the pointer P at a time that the user changes the shape of the hand H.

As shown in FIG. 11, the user may conduct a gesture while the hand H is open until the time t1, while a single finger is open from the time t1 to a time t2, and while the hand H is open after the time t2. The controller 180 may change the set value depending on the state of the hand H. For example, the controller 180 may control the pointer P based on a first set value until the time t1, based on a second set value from the time t1 to the time t2, and a third set value from the time t2 to a time t3. For example, the controller 180 may control the pointer P based on two or more set values.

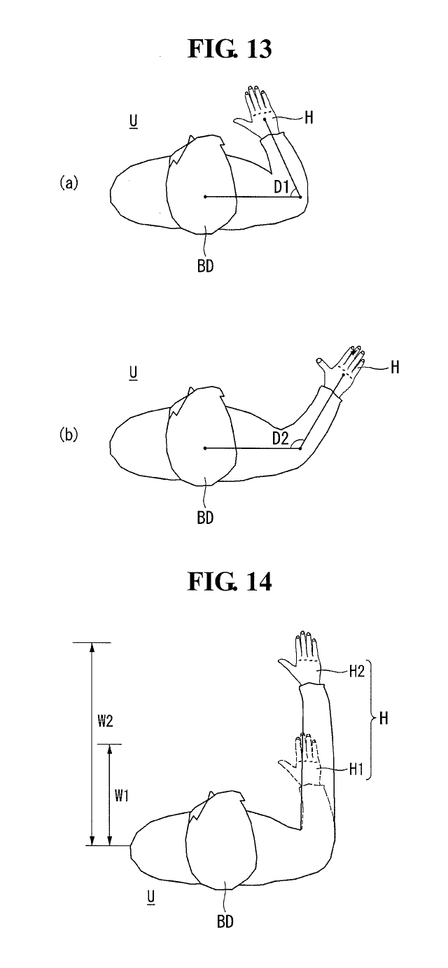

FIGS. 12 and 13 are views illustrating an example where the device shown in FIG. 1 changes a set value depending on a relationship between a hand and body.

Referring to FIGS. 12 and 13, the device 100 may change a set value depending on relative locations of the body BD and hand H.

As shown in FIGS. 12A and 12B, the hand H of the user U may be left away from his body BD by a distance of W1 or W2.

The distance W1 may be shorter than the distance W2. For example, the distance W1 may be formed when the user U bends his arm to have an angle less than a predetermined angle and the distance W2 may be formed when the user U spreads his arm to have an angle more than the predetermined angle.

The camera 121 may sense a distance between the body BD and the hand H.

Based on the sensed distance between the body BD and the hand H, the controller 180 may change a set value. For example, the controller 180 may enable the pointer P to be moved based on a first set value when the distance between the body BD and the hand H is W1 or less and based on a second set value when the distance between the body BD and the hand H is W1 or more.

The controller 180 may change a set value based on a travelling speed of the hand H. For example, the controller 180 may enable the pointer P to be moved based on the first set value when the travelling speed of the hand H is slow and based on the second set value when the travelling speed of the hand H is fast.

As shown in FIGS. 13A and 13B, the user U may bend his arm so that his hand H forms an angle D1 or D2 with respect to his body BD.

The camera 121 may sense the angle between the hand H and the body BD.

The controller 180 may change a set value based on the angle between the hand H and the body BD. For example, the controller 180 may enable the pointer P to be moved based on a first set value when the angle between the hand H and the body BD is D1 or less and based on a second set value when the angle between the hand H and the body BD is more than D1.

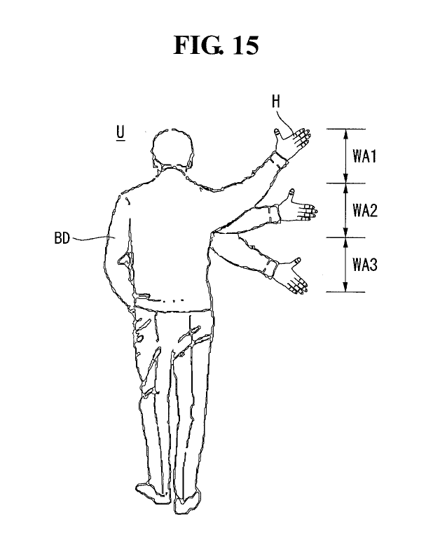

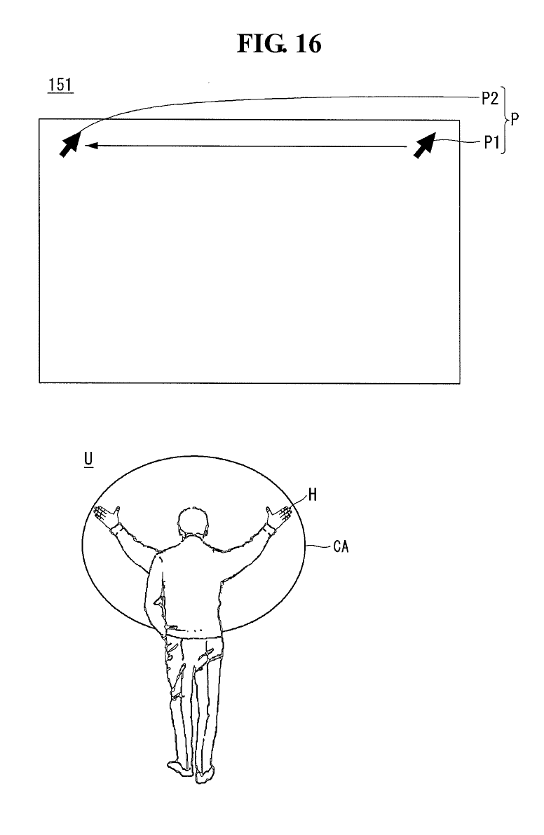

FIGS. 14 and 15 are views illustrating an example where the device shown in FIG. 1 changes a set value depending on a distance between a hand and a body.

Referring to FIGS. 14 and 15, the controller 180 of the device 100 may change a set value depending on a distance of a hand H from a body BD.

As shown in FIG. 14, the hand H may be located at a point H1 which is spaced away from the body BD by a distance W1 toward a front side or at a point H2 which is spaced away from the body BD by a distance W2 toward the front side.

The controller 180 may change a set value depending on a location of the hand H that spreads toward the front side from the body BD. For example, when the hand H moves left and right while spread by a distance less than the distance W1, the controller 180 may enable the pointer P to be moved based on a first set value and when the hand H moves left and right while spread by a distance not less than the distance W1, the controller 180 may enable the pointer P to be moved based on a second set value.

As shown in FIG. 15, the hand H may be located in one of areas WA1 to WA3 in upper and lower directions of the body BD.

The controller 180 may enable the pointer P to be moved based on a set value corresponding to a predetermined area of the areas WA1 to WA3 when the hand H is moved left and right in the predetermined area of the areas WA1 to WA3. For example, the controller 180 may move the pointer P so that a ratio of 1:1 corresponds to the hand's movement in the area WA1, so that a ratio of 1:0.5 corresponds to the hand's movement in the area WA2, and so that a ratio of 1:0.1 corresponds to the hand's movement in the area WA3.

FIG. 16 is a view illustrating a relationship between a radius of a hand and a movement of a pointer in the device shown in FIG. 1.

As shown in FIG. 16, the device 100 may enable a travelling range CA of a hand H to correspond to the entire area of the display unit 151.

When the hand H is moved from a point, the hand H may be moved within the travelling range.

The controller 180 may enable the travelling range CA of the hand H to correspond to the entire area of the display unit 151. For example, points included in a maximum area that a user U may reach from a current point by spreading his hand H may respectively match points included in a maximum area of the display unit 151. For example, the controller 180 may enable the pointer P to be moved from a right and uppermost point P1 of the display unit 151 to a left and uppermost point P2 of the display unit 151 when the hand H is moved from a right and uppermost end to a left and uppermost end.

When a gesture of the hand H is beyond the travelling range CA which is a limit to which the user U may spread his hand H from a predetermined point, the controller 180 may determine that the user U moves from the predetermined point. Under this circumstance, the controller 180 may not reflect a movement of the hand H that is beyond the travelling range CA. For example, when the hand H go beyond the travelling range CA, the controller 180 may neglect the gesture and keep the pointer P stationary at the predetermined point.

The controller 180 may determine the travelling range CA based on at least one of the arm length, sex, age, height, and weight of the user U. For example, if the user U is determined to be short in height, the controller 180 may determine that the travelling range CA is small.

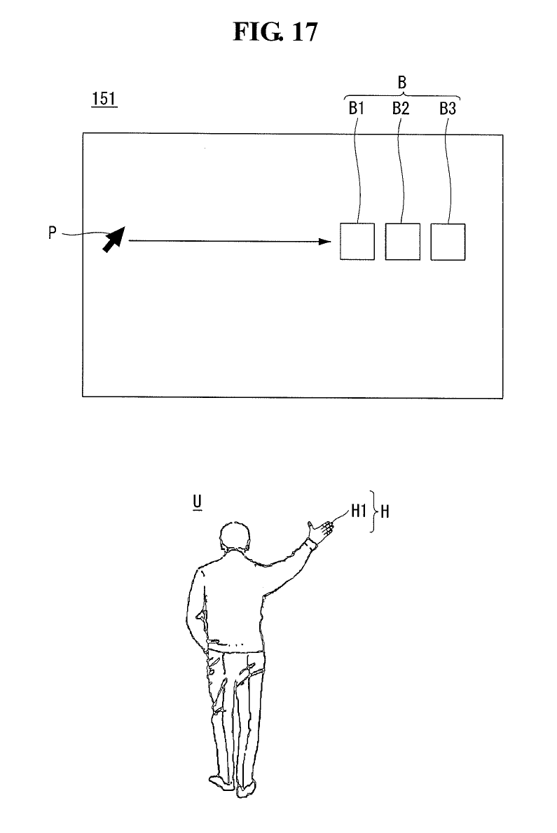

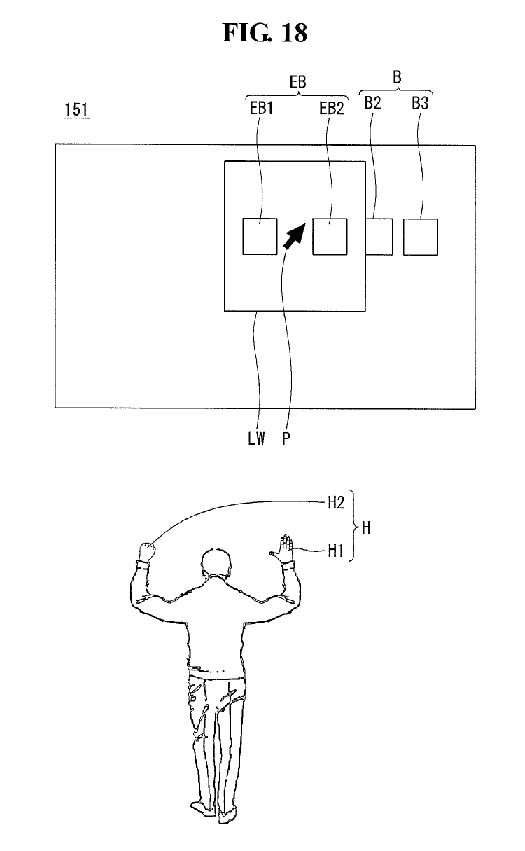

FIGS. 17 and 18 are views illustrating an example where the device shown in FIG. 1 expands the screen depending on a gesture.

Referring to FIGS. 17 and 18, the controller 180 of the device 100 may expand and display at least one portion of the screen of the display unit 151 when a user U makes a predetermined gesture.

As shown in FIG. 17, the user U may conduct a gesture using his right hand H1. For example, the user U may conduct a gesture of moving the pointer P near buttons B.

When the pointer P is moved near the buttons B as shown in FIG. 18, the user may conduct a predetermined gesture using his left hand H2. For example, the user may conduct a gesture of raising his left hand H2 and making a fist.

When the user conducts the gesture of raising the left hand H2 and making a fist, the controller 180 may expand and display an area near a point where the pointer P is located on the screen. For example, the controller 180 may display first and second expanded buttons EB1 and EB2 in an expansion window LW. When the first and second expanded buttons EB1 and EB2 in the expansion window LW, the user may conduct a gesture of hovering his right hand H1 left and right to relocate the pointer P over the buttons B to be desired to select.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A device comprising:
a sensing unit configured to sense gestures of a user, wherein the sensing unit senses the gestures without the user physically contacting the device or any hardware in communication with the device; and
a controller configured to:
generate a display signal to cause a display unit to display a pointer,
receive, from the sensing unit, information associated with a first gesture of the user sensed by the sensing unit,
generate, while receiving information associated with the first gesture, a display signal to cause the display unit to display the pointer with movement corresponding to a function of the first gesture and a first set value,
change, while receiving information associated with the first gesture, the first set value to a second set value, the first set value being different than the second set value, and
generate, while receiving information associated with the first gesture and after changing the first set value to the second set value, a display signal to cause the display unit to display the pointer with movement corresponding to a function of the first gesture and the second set value.

2. The device of claim 1, wherein:
the first set value corresponds to a first ratio between a trajectory distance of the first gesture and a corresponding travel distance of the pointer;
the second set value corresponds to a second ratio between a trajectory distance of the first gesture and a corresponding travel distance of the pointer;
the controller is configured to generate a display signal to cause the display unit to display the pointer with movement corresponding to a function of the first gesture and the first set value by generating a display signal to cause the display unit to display the pointer moving a first travel distance corresponding to the first ratio and a first trajectory distance of the first gesture; and
the controller is configured to generate a display signal to cause the display unit to display the pointer with movement corresponding to a function of the first gesture and the second set value by generating a display signal to cause the display unit to display the pointer moving a second travel distance corresponding to the second ratio and a second trajectory distance of the first gesture after the first set value has been changed to the second set value.

3. The device of claim 2, wherein the first ratio is smaller than the second ratio.

4. The device of claim 1, wherein the controller is configured to change the first set value to the second set value based on the sensing unit sensing a change in the first gesture.

5. The device of claim 4, wherein:
the controller is configured to receive information associated with the first gesture of the user by receiving information associated with the first gesture of the user being performed using a hand;
the sensing unit is configured to sense a change in the shape of the hand of the first user performing the first gesture; and
the controller is configured to change the first set value to the second set value based on the sensing unit sensing the change in the shape of the hand of the user performing the first gesture.

6. The device of claim 4, wherein:
the controller is configured to receive information associated with the first gesture of the user by receiving information associated with the first gesture of the user being performed using a hand;
the sensing unit is configured to sense a change in a distance between a body of the user performing the first gesture and the hand of the user and an angle between the body and the hand; and
the controller is configured to change the first set value to the second set value based on the sensing unit sensing the change in the distance between the body of the user performing the first gesture and the hand of the user and an angle between the body and the hand.

7. The device of claim 4, wherein:
the controller is configured to receive information associated with the first gesture of the user by receiving information associated with the first gesture of the user being performed using a hand;
the sensing unit is configured to sense a change in at least one of a degree at which the hand of the user performing the first gesture extends forward from a body of the user or a height of the hand of the user with respect to the body of the user; and
the controller is configured to change the first set value to the second set value based on the sensing unit sensing the change in least one of the degree at which the hand of the user performing the first gesture extends forward from the body of the user or the height of the hand of the user with respect to the body of the user.

8. The device of claim 4, wherein:
the controller is configured to receive information associated with the first gesture of the user by receiving information associated with the first gesture of the user being performed using a hand;
the sensing unit is configured to sense a change in a travelling speed of the hand of the user performing the first gesture; and
the controller is configured to change the first set value to the second set value based on the sensing unit sensing the change in the travelling speed of the hand of the user performing the first gesture.

9. The device of claim 1, wherein the controller is configured to:
generate a display signal to cause the display unit to display a selectable object configured to receive a selection signal;
determine that the pointer has moved within a certain distance of the selectable object; and
change, based on determining that the pointer has moved within the certain distance of the selectable object, the first set value to the second set value.

10. The device of claim 1, wherein:
the sensing unit is configured to sense data indicative of a maximum reach of the user;
the controller is configured to:
determine, based on the sensed data, the maximum reach of the user; and
set the first set value based on the maximum reach of the user.

11. The device of claim 1, wherein the controller is configured to:
receive, from the sensing unit, information associated with a second gesture of the user sensed by the sensing unit; and
display, based on receiving the information associated with the second gesture of the user, an expanded viewing area at a current position at which the pointer is displayed, the expanded viewing area displaying a magnified view of a region around the current point at which the pointer is displayed.

12. The device of claim 11, wherein:
the controller is configured to receive information associated with the first gesture of the user by receiving information associated with the first gesture of the user being performed using a first hand; and
the controller is configured to receive information associated with the second gesture of the user by receiving information associated with the second gesture of the user being performed using a second hand.

13. A method comprising:
generating, at a device, a display signal to cause a display unit to display a pointer;
receiving, from a sensing unit, information associated with a first gesture of a user sensed by a sensing unit, the sensing unit being configured to sense gestures of the user without the user physically contacting the device or any hardware in communication with the device;
generating, while receiving information associated with the first gesture, a display signal to cause the display unit to display the pointer with movement corresponding to a function of the first gesture and a first set value;
changing, while receiving information associated with the first gesture, the first set value to a second set value, the first set value being different than the second set value; and
generating, while receiving information associated with the first gesture and after changing the first set value to the second set value, a display signal to cause the display unit to display the pointer with movement corresponding to a function of the first gesture and the second set value.

14. The device of claim 13, wherein:
the first set value corresponds to a first ratio between a trajectory distance of the first gesture and a corresponding travel distance of the pointer;
the second set value corresponds to a second ratio between a trajectory distance of the first gesture and a corresponding travel distance of the pointer;
generating a display signal to cause the display unit to display the pointer with movement corresponding to a function of the first gesture and the first set value includes generating a display signal to cause the display unit to display the pointer moving a first travel distance corresponding to the first ratio and a first trajectory distance of the first gesture; and
generating a display signal to cause the display unit to display the pointer with movement corresponding to a function of the first gesture and the second set value includes generating a display signal to cause the display unit to display the pointer moving a second travel distance corresponding to the second ratio and a second trajectory distance of the first gesture after the first set value has been changed to the second set value.

15. The method of claim 13, wherein the first ratio is smaller than the second ratio.

16. The method of claim 13, wherein the first set value is changed to the second set value based on the sensing unit sensing a change in the first gesture.

17. The method of claim 16, wherein:
receiving information associated with the first gesture of the user includes receiving information associated with the first gesture of the user being performed using a hand;
the sensing unit is configured to sense a change in the shape of the hand of the first user performing the first gesture; and
changing the first set value to the second set value is based on the sensing unit sensing the change in the shape of the hand of the user performing the first gesture.

18. The method of claim 16, wherein:
receiving information associated with the first gesture of the user includes receiving information associated with the first gesture of the user being performed using a hand;
the sensing unit is configured to sense a change in a distance between a body of the user performing the first gesture and the hand of the user and an angle between the body and the hand; and
changing the first set value to the second set value is based on the sensing unit sensing the change in the distance between the body of the user performing the first gesture and the hand of the user and an angle between the body and the hand.

19. The method of claim 16, wherein:
receiving information associated with the first gesture of the user includes receiving information associated with the first gesture of the user being performed using a hand;
the sensing unit is configured to sense a change in at least one of a degree at which the hand of the user performing the first gesture extends forward from a body of the user or a height of the hand of the user with respect to the body of the user; and
changing the first set value to the second set value is based on the sensing unit sensing the change in least one of the degree at which the hand of the user performing the first gesture extends forward from the body of the user or the height of the hand of the user with respect to the body of the user.

20. The device of claim 16, wherein:
receiving information associated with the first gesture of the user includes receiving information associated with the first gesture of the user being performed using a hand;
the sensing unit is configured to sense a change in a travelling speed of the hand of the user performing the first gesture; and
changing the first set value to the second set value is based on the sensing unit sensing the change in the travelling speed of the hand of the user performing the first gesture.

21. The method of claim 13, further comprising:
generating a display signal to cause the display unit to display a selectable object configured to receive a selection signal;
determining that the pointer has moved within a certain distance of the selectable object; and
changing, based on determining that the pointer has moved within the certain distance of the selectable object, the first set value to the second set value.

22. The method of claim 13, wherein:
the sensing unit is configured to sense data indicative of a maximum reach of the user;
the method further comprising:
determining, based on the sensed data, the maximum reach of the user; and
setting the first set value based on the maximum reach of the user.

23. The method of claim 13, further comprising:
receiving, from the sensing unit, information associated with a second gesture of the user sensed by the sensing unit; and
displaying, based on receiving the information associated with the second gesture of the user, an expanded viewing area at a current position at which the pointer is displayed, the expanded viewing area displaying a magnified view of a region around the current point at which the pointer is displayed.

24. The method of claim 23, wherein:
receiving information associated with the first gesture of the user includes receiving information associated with the first gesture of the user being performed using a first hand; and
receiving information associated with the second gesture of the user includes receiving information associated with the second gesture of the user being performed using a second hand.
